(19) United States
(12) Patent Application Publication
(10) Pub. No.: US 2010/0054389 A1
(43) Pub. Date: Mar. 4, 2010

(54) MIXED OXIDE FUEL ASSEMBLY

(76) Inventor: Robert J. Fetterman, Murrysville, PA (US)

Correspondence Address: WESTINGHOUSE ELECTRIC COMPANY, LLC, P.O. BOX 355, PITTSBURGH, PA, 15230-0355, US

(21) Appl. No.: 12/198,287

(22) Filed: Aug. 26, 2008

(51) Int. Cl. G21C 3/17; G21C 3/328

(52) U.S. Cl. 376/417; 376/431; 376/435

(57) ABSTRACT

A pressurized water nuclear reactor fuel assembly designed to burn mixed oxide fuel that employs a fully annular fuel pellet stack in the fuel rods, and radial enrichment zoning within the assembly such that the intra-assembly rod power distribution is relatively smooth regardless of the characteristics of the adjacent assemblies.

### BACKGROUND OF THE INVENTION

1. Field of the Invention

This invention pertains generally to pressurized water reactor fuel assemblies and more particularly to such fuel assemblies that employ mixed oxide fuel.

2. Description of Related Art

The primary side of nuclear reactor power generating systems which are cooled with water under pressure comprises a closed circuit which is isolated and in heat exchange relationship with a secondary side for the production of useful energy. The primary side comprises the reactor vessel enclosing 5a core internal structure that supports a plurality of fuel assemblies containing fissile material, the primary circuit within heat exchange steam generators, the inner volume of a pressurizer, pumps and pipes for circulating pressurized water; the pipes connecting each of the steam generators and pumps to the reactor vessel independently. Each of the parts of the primary side comprising a steam generator, a pump and a system of pipes which are connected to the vessel form a loop of the primary side.

For the purpose of illustration, FIG. 1 shows a simplified nuclear reactor primary system, including a generally cylindrical reactor pressure vessel 10 having a closure head 12 enclosing a nuclear core 14. A liquid reactor coolant, such as water is pumped into the vessel 10 by pump 16 through the core 14 where heat energy is absorbed and is discharged to a heat exchanger 18, typically referred to as a steam generator, in which heat is transferred to a utilization circuit (not shown), such as a steam driven turbine generator. The reactor coolant is then returned to the pump 16, completing the primary loop. Typically, a plurality of the above described loops are connected to a single reactor vessel 10 by reactor coolant piping 20.

An exemplary reactor design is shown in more detail in FIG. 2. In addition to the core 14 comprised of a plurality of parallel, vertical, co-extending fuel assemblies 22, for purposes of this description, the other vessel internal structures can be divided into the lower internals 24 and the upper internals 26. In conventional designs, the lower internals function is to support, align and guide core components and instrumentation as well as direct flow within the vessel. The upper internals restrain or provide a secondary restraint for the fuel assemblies 22 (only two of which are shown for simplicity in this figure), and support and guide instrumentation and components, such as control rods 28. In the exemplary reactor shown in FIG. 2, coolant enters the reactor vessel 10 through one or more inlet nozzles 30, flows down through an annulus between the vessel and the core barrel 32, is turned to 180° in a lower plenum 34, passes upwardly through a lower support plate 37 and a lower core plate 36 upon which the fuel assemblies 22 are seated and through and about the assemblies. In some designs, the lower support plate 37 and the lower core plate 36 are replaced by a single structure, the lower core support plate, at the same elevation as 37. The coolant flow through the core and surrounding area 38 is typically large on the order of 1.19×10⁶ liters per minute at a velocity of approximately 6.1 meters per second. The resulting pressure drop and frictional forces tend to cause the fuel assemblies to rise, which movement is restrained by the upper internals, including a circular upper core plate 40. Coolant exiting the core 14 flows along the underside of the upper core plate 40 and upwardly through a plurality of perforations 42. The coolant then flows upwardly and radially to one or more outlet nozzles 44.

The upper internals 26 can be supported from the vessel or the vessel head and include an upper support assembly 46. Loads are transmitted between the upper support assembly 46 and the upper core plate 40, primarily by a plurality of support columns 48. A support column is aligned above a selected fuel assembly 22 and perforations 42 in the upper core plate 40.

The rectilinearly moveable control rods 28 typically include a drive shaft 50 and a spider assembly 52 of neutron poison rods that are guided through the upper internals 26 and into aligned fuel assemblies 22 by control rod guide tubes 54. The guide tubes are fixedly joined to the upper support assembly 46 and connected by a split pin 56 force fit into the top of the upper core plate 40. The pin configuration provides for ease of guide tube assembly and replacement if ever necessary and assures that the core loads, particularly under seismic or other high loading accident conditions are taken primarily by the support columns 48 and not the guide tubes 54. This support column arrangement assists in retarding guide tube deformation under accident conditions which could detrimentally affect control rod insertion capability.

FIG. 3 is an elevational view, represented in vertically shortened form, of a fuel assembly being generally designed by reference character 22. The fuel assembly 22 is the type used in a pressurized water reactor and has a structural skeleton which, at its lower end includes a bottom nozzle 58. The bottom nozzle 58 supports the fuel assembly 22 on the lower core support plate 36 in the core region 14 of the nuclear reactor. In addition to the bottom nozzle 58, the structural skeleton of the fuel assembly 22 also includes a top nozzle 62 at its upper end and an number of guide tubes or thimbles 55, which extend longitudinally between the bottom and top nozzles 58 and 62 and at opposite ends are rigidly attached thereto.

The fuel assembly 22 further includes a plurality of transverse grids 64 axially spaced along and mounted to the guide thimbles 55 (also referred to as guide tubes) and an organized array of elongated fuel rods 66 transversely spaced and supported by the grids 64. Although it cannot be seen in FIG. 3 the grids 64 are conventionally formed from orthogonal straps that are interleafed in an egg crate pattern with the adjacent interface of four straps defining approximately square support cells through which the fuel rods 66 are supported in transversely spaced relationship with each other. In many conventional designs springs and dimples are stamped into the opposing walls of the straps that form the support cells. The springs and dimples extend radially into the support cells and capture the fuel rods therebetween; exerting pressure on the fuel rod cladding to hold the rods in position. Also, the assembly 22 has an instrumentation tube 68 located in the center thereof that extends between and is either mounted to or captured by the bottom and top nozzles 58 and 62. With such an arrangement of parts, fuel assembly 22 forms an integral unit capable of being conveniently handled without damaging the assembly of parts.

As mentioned above, the fuel rods 66 in the array thereof in the assembly 22 are held in spaced relationship with one another by the grids 64 spaced along the fuel assembly length. Each fuel rod 66 includes a plurality of nuclear fuel pellets 70 and is closed at its opposite ends by upper and lower end plugs 72 and 74. the pellets 70 are maintained in a stack by a plenum spring 76 disposed between the upper end plug 72 and the top of the pellet stack. Conventionally, above the pellet stack between the top pellet 70 and the upper end plug 72 is a plenum area 60 reserved for the accumulation of fission gases which are generated during the fuel burn-up in the course of reactor operation. The fuel pellets 70, composed of fissile material, are responsible for creating the reactive power of the reactor. The cladding 68 which surrounds the pellets functions as a barrier to prevent the fission by-products from entering the coolant and further contaminating the reactor system.

To control the fission process, a number of control rods 28 are reciprocally moveable in the guide thimbles 55 located at predetermined positions in the fuel assembly 22. Specifically, a rod cluster control mechanism 80 positioned above the top nozzle 62 supports the control rods 28. The control mechanism 80 has an internal threaded cylindrical hub member 82 with a plurality of radially extending flukes or arms 52. Each arm 52 is interconnected to the control rods 28 such that the control rod mechanism 80 is operable to move the control rods vertically in the guide thimbles 54 to thereby control the fission process in the fuel assembly 22, under the motive power of control rod drive shafts 50 which are coupled to the control rod hubs 80, all in a well-known manner.

There is a large excess of plutonium resulting from the retirement of nuclear weapons. One option recommended by the National Academy of Sciences for the disposal of the excess weapons grade plutonium is conversion to spent fuel. In this approach, excess weapons plutonium is converted to plutonium oxide (PuO₂) and used in a mixed oxide (PuO₂—UO₂) form without reprocessing as fuel for existing nuclear reactors. This results in a spent form which is “proliferation resistant” and that meets the “spent fuel standard” which is recommended by the National Academy of Sciences. This is becoming very attractive to power generation utilities because it reduces the cost of nuclear fuel for nuclear reactor powered electrical generation facilities. For example, the European Utility Requirements Document states that the next generation European Passive Plant reactor core design shall be optimized for UO₂ fuel assemblies, with provisions made to allow for up to 50% mixed oxide (MOX) fuel assemblies. Use of MOX in the core design will have significant impacts on key physics parameters and safety analysis assumptions. Furthermore, the MOX fuel rod design must also consider fuel performance criterion important to maintain the integrity of the fuel rod over its intended life time. The MOX approach requires: 1) conservative, realistic core performance characteristics which are similar to those for current uranium core designs; 2) that the technique minimize licensing risks by avoiding any erosion of safety margins compared to those for currently licensed conventional uranium core designs; 3) that impacts on plant operation be minimized or totally avoided; and 4) that the energy extracted from the MOX fuel be maximized to provide the best economics.

Accordingly, a nuclear core and fuel rod design is desired that will satisfy that criteria and be substantially interchangeable with a 100% UO₂ core design.

### SUMMARY OF THE INVENTION

This invention achieves the foregoing objectives by providing a new pressurized water reactor fuel assembly designed to burn MOX fuel. The fuel assembly employs a traditional fuel assembly skeleton and fuel rods having a tandem arrangement of mixed oxide fuel pellets stacked within and along a portion of the fuel rod's tubular cladding. At least substantially all of the mixed oxide pellets have an annulus void of solid matter through which the axis of the tubular cladding extends. The cladding is hermetically sealed at either end with an end plug and the remainder of the interior area within the cladding between the end plug and the mixed oxide fuel pellet stack defines one or more gas plenum(s). The plenum(s) cooperates with the annulus in each of the fuel pellets for the collection of fission gases generated during fuel burn-up. The annulus in each of the fuel pellets is approximately 1 to 4 mm in diameter and preferably 2 to 4 mm in diameter.

In one preferred embodiment the mixed oxide fuel elements do not contain any burnable absorber. In another embodiment with higher fissile Pu loadings some of the rods within a fuel assembly may contain a burnable absorber. In accordance with this invention, in the case of the latter embodiment the rods containing a burnable absorber may comprise “tails” or “natural” uranium doped with a burnable absorber such as Gd₂O₃. Preferably, a plenum is defined at each end of the stack of fuel pellets between the fuel pellet stack and the end plugs, for the collection of fission gases.

Preferably, the spaced array of the plurality of fuel rods in the fuel assembly is arranged in a radial enrichment zoning pattern with the weight percent enrichment of the fuel rods decreasing as one moves radially outward from the center of the fuel assembly from one zone to the next. Desirably, the radial enrichment zoning pattern has at least three zones. Preferably the relative weight/percent enrichment is about 1.00 for a central zone, approximately 0.65 for an intermediate zone and approximately 0.45 for an outer peripheral zone. In a 17×17 fuel rod assembly array embodiment of this invention the central zone preferably has approximately 72 fuel rods, the intermediate zone has approximately 128 fuel rods and the outer peripheral zone has approximately 64 fuel rods. Preferably the outer peripheral zone consists of an outer peripheral row of fuel rods that circumscribes the fuel assembly.

### BRIEF DESCRIPTION OF THE DRAWINGS

A further understanding of the invention can be gained from the following description of the preferred embodiments when read in conjunction with the accompanying drawings in which:

FIG. 1 is a simplified schematic of a nuclear reactor system to which this invention can be applied;

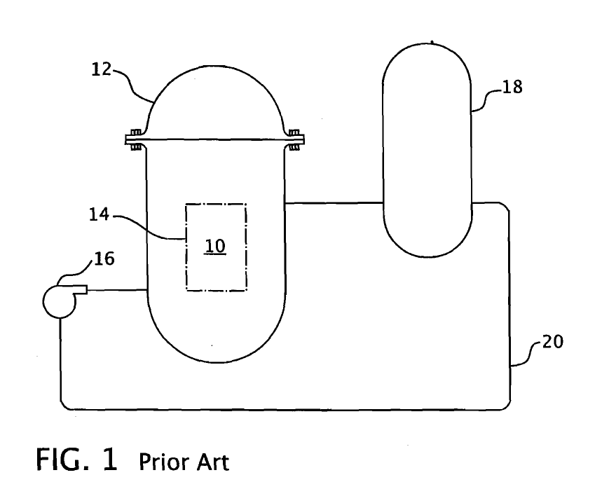

FIG. 2 is an elevational view, partially in section, of a nuclear reactor vessel and internal components to which this invention can be applied;

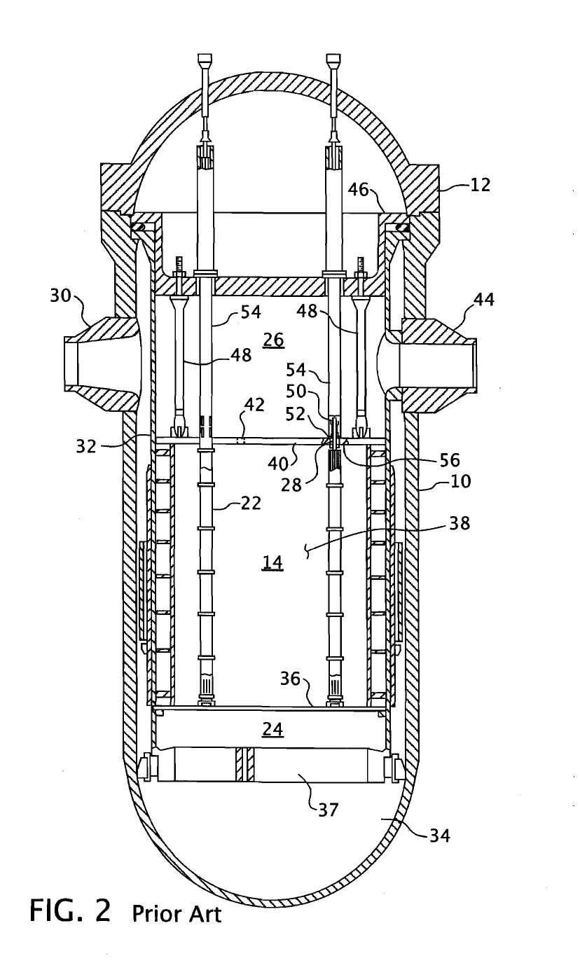

FIG. 3 is an elevational view, partially in section, of a fuel assembly illustrated in vertically shortened form, with parts broken away for clarity;

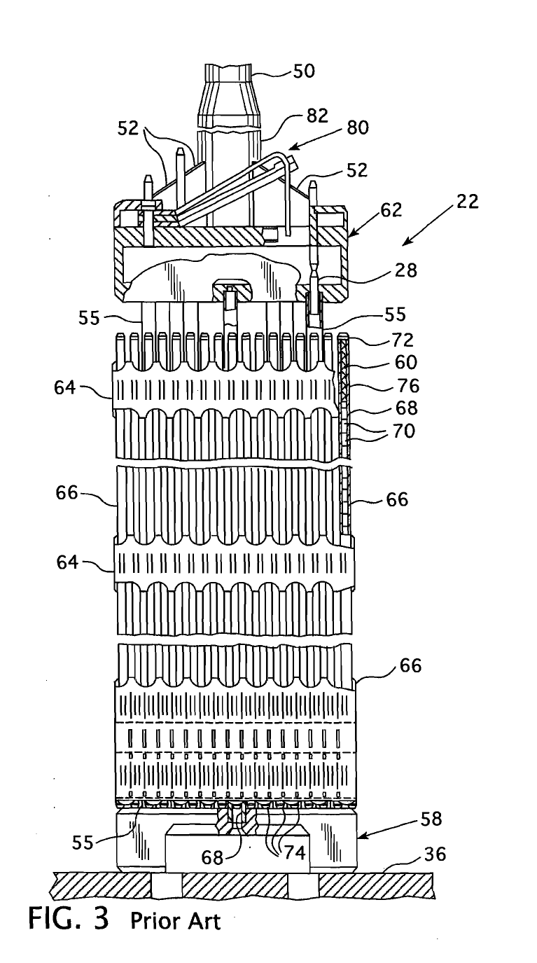

FIG. 4 is an elevational view, partially in section, that shows one embodiment of a fuel rod constructed in accordance with this invention;

FIG. 5 is a plan view of an intermediate axial section of a fuel assembly that shows the radial enrichment zoning pattern of this invention'

FIG. 6 is a graphical comparison of the reactivity of a UO₂ assembly without and with 8 Gd₂O₃ rods and an MOX assembly designed in accordance with this invention;

FIG. 7 is a map showing the mixed MOX/UO₂ core design loading pattern in quarter-core cyclic symmetry.

### DESCRIPTION OF THE PREFERRED EMBODIMENTS

A mixed oxide core of UO₂ and MOX fuel presents two design challenges not found in all-UO₂ cores. First of all, MOX fuel rods operate at elevated temperatures relative to UO₂ fuel rods at the same linear heat rate; that is, the same number of kilowatts of power per foot of rod. This leads to higher fission gas release rates and higher rod internal pressures in the MOX fuel rods, limiting the useful lifetime of the fuel. A limiting discharge burn-up for MOX fuel is in the order of 40 to 50 MWd (megawatt days)/kg HM (kilograms of heavy metal), compared to about 62 to 75 MWd/kg U for UO₂ fuel. In a high power density core, this burn-up limitation can restrict the number of cycles between re-fuelings that an MOX assembly can operate to two or at the most three cycles. The second design challenge arises from the large variations in neutron flux spectrum between UO₂ and MOX assemblies. UO₂ assemblies essentially act as a strong thermal neutron source to adjacent MOX assemblies, which can lead to excessive power peaking in the MOX fuel unless the fuel rods and the lattice are properly designed.

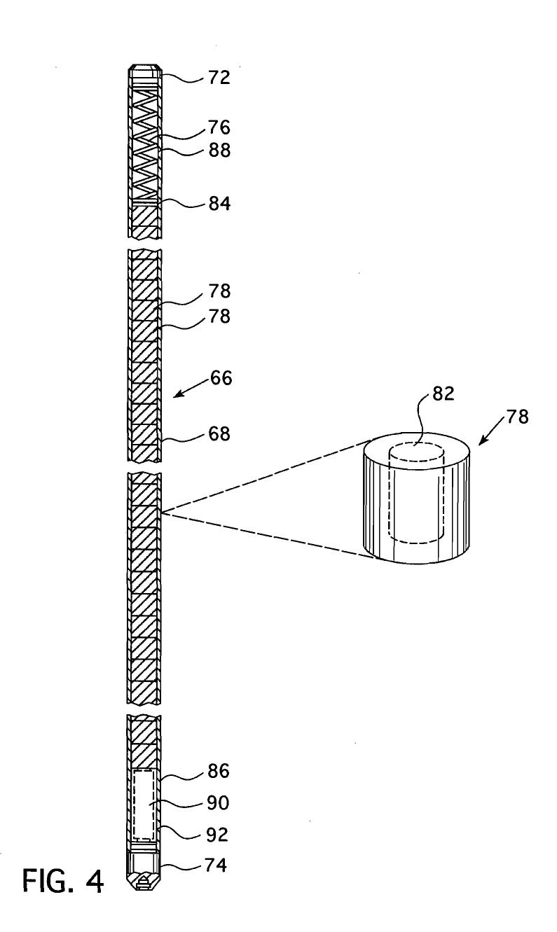

Some conventional blanket UO₂ assemblies employ fuel rods with annular pellets in the lower 8″ (20.32 centimeters) and upper 8″ (20.32 centimeters) of the fuel pellet stacks. This invention as seen in FIG. 4, employs pellets 78 having an annular opening 82, over the entire active region of the cladding 68 of the fuel rods 66. In one embodiment, the active region extends from the lower end plug 74 to an upper elevation 84 that is spaced from the upper end cap 72 to form a plenum 88 that together with the combined annulus 82 of the pellets 78 form a reservoir for the collection of fissions gases generated during fuel burn-up. The central annulus 82 serves two purposes. In the first instance the annulus provides additional fuel rod plenum volume to accommodate the higher fission gas release rate of MOX fuel. Secondly, the annulus 82 lowers the peak and average temperature of the fuel pellets 78, reducing the fission gas release rate. The combination of these benefits will allow the annular MOX fuel rod to obtain exposures much higher than a typical solid nuclear fuel rod. While it might be possible to satisfy the operating specifications of the reactor employing several solid fuel pellets at the lower end of the stack to increase the active fuel volume, analyses have shown that it's preferable to have an annual opening 82 in all of the pellets 78 along the entire length of the pellet stack. The size of the annulus is a trade-off between providing more active material and thus, more power output or reducing temperatures and providing a greater fission gas collection volume to lower the internal pressure of the fuel rod, analyses have shown that it's preferable to have an annulus 82 with a diameter of approximately between one and four mm, and most preferably between two and four mm. A case study, assuming annular MOX pellets along the entire length of the fuel pellet stack of the same geometric proportions as a standard Westinghouse Electric Company LLC annular blanket pellet demonstrated that the annular MOX fuel rod could obtain exposures of 70 MWd/kg HM without exceeding the reactor cooling system operating pressure of approximately 15.5 MPa.

In another preferred embodiment, as shown in FIG. 4, the fuel rod is provided with a second plenum 90 between the lower end plug 74 and the bottom of the fuel stack 86 to further accommodate the fission gases generated during fuel burn-up. The fuel stack is supported spaced from the lower end cap 74 by a standoff 92 that's more fully described in U.S. patent application Ser. No. 12/053,771, filed Mar. 24, 2008 and assigned to the Assignee of this application.

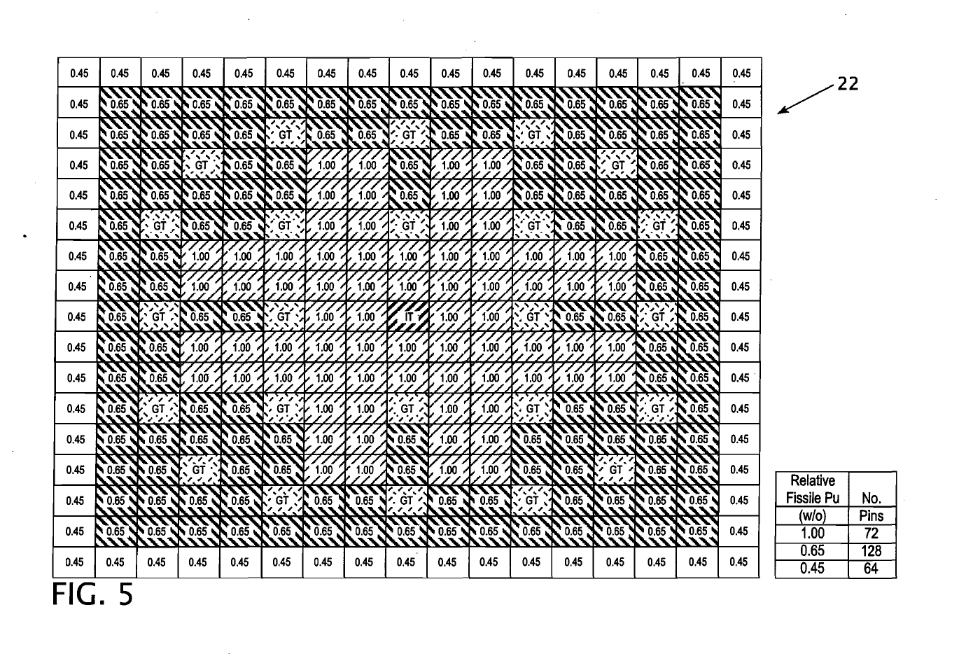

This invention employs a radial variation in the fissile Pu content of the MOX rods within the assembly as illustrated in FIG. 5. FIG. 5 shows a map of an exemplary 17×17 fuel assembly with the relative fissile Pu enrichments shown in the fuel locations around the guide tubes (GT) and the instrumentation tube (IT). The radial enrichment zoning for the assembly 22 is employed to allow increased flexibility in how the MOX assemblies are placed within the reactor core. Without radial enrichment zoning, a MOX assembly placed directly adjacent to a UO₂ assembly will see a large increase in power in the peripheral row of fuel rods possibly leading to exceeding their peaking factor supported by the safety analysis. This design will use an enrichment zoning of three different enrichments within the MOX assembly. The relative enrichment of the three different rod types is set such that the intra-assembly rod power distribution is relatively smooth regardless of the characteristics of the adjacent assembly, in turn leading to lower peaking factors for the same assembly average power. Since the peak to average power ratio is improved relative to an unzoned assembly, the MOX assemblies can be taken to higher average powers, which means the MOX rods can be loaded with higher fissile Pu contents. In a core with a mixture of MOX and UO₂ fuel assemblies, this means the enrichment of the UO₂ fuel can be reduced for the same core energy output, reducing the UO₂ fuel cost. The preferred radial zoning, shown in FIG. 5 has a relative fissile plutonium enrichment in weight/percent of 1.00 in the central zone, 0.65 in the intermediate blanket and 0.45 in the peripheral blanket which is the outer row that circumscribes the fuel assembly 22.

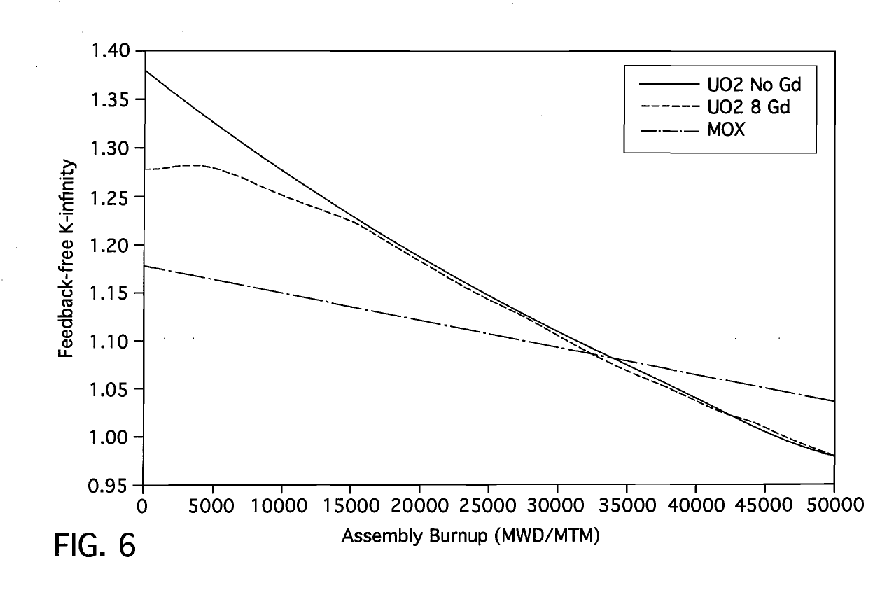

FIG. 6 is a graphical comparison of the reactivity of UO₂ assemblies without and with eight Gd₂O₃ rods and the MOX assembly design described above. The UO₂ and the MOX assembly designs have nearly the same reactivity at approximately 34 GWD/MTM (gigawatt days/Metric Tons Metal) of assembly exposure. This is fairly close to the assembly average exposure of the UO₂ fuel after two cycles of operation. The MOX assemblies will exceed this exposure during their second cycle of operation.

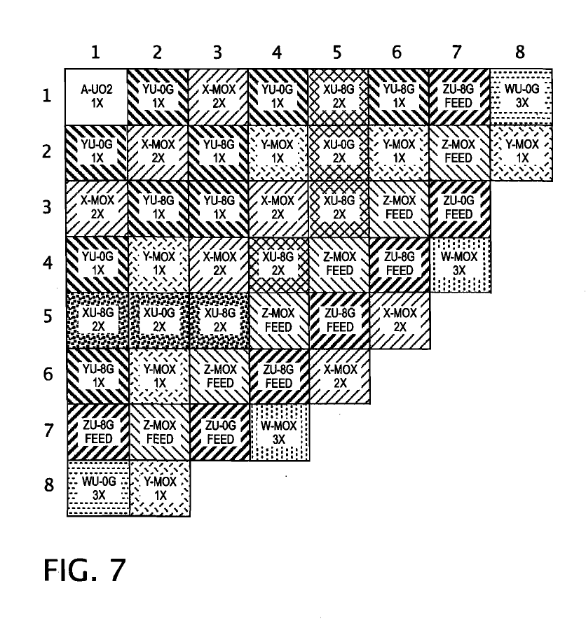

The mixed MOX/UO₂ core design loading pattern is shown in FIG. 7 in quarter-core cyclic symmetry. The 48 assembly feed region is divided into two sub-regions: ZU with 24 assemblies of 4.05 weight/percent ²³⁵U and Z-MOX with 24 assemblies zoned as shown in FIG. 5. In addition, the top and bottom eight inches (20.32 centimeters) of each ZU assembly is an axial blanket of 3.2 weight/percent ²³⁵U. The number of Gd₂O₃ rods per ZU assembly are also shown in FIG. 7, with a total of 64 2 weight/percent and 64 8 weight/percent rods used per feed region. Each ZU assembly with Gd₂O₃ rods uses a combination of both rod types. The Z-MOX assemblies do not have Gd₂O₃ rods. In another embodiment with higher fissile Pu loadings some of the rods within a MOX fuel assembly may contain a burnable absorber. In the latter embodiment the rods containing a burnable absorber may comprise “tails” or “natural” uranium doped with a burnable absorber such as Gd₂O₃.

The combination of employing fully annular MOX fuel rods with radial enrichment zoning enables a full UO₂ core to be substituted with 50% MOX fuel assemblies with no detrimental performance penalty. The operation of the core is enhanced using a “mechanical shim” or MSHIM core power distribution control strategy that will enable load follow. The primary difference between MSHIM and the traditional mode of operation in current generation plants is that MSHIM replaces the frequent manipulation of soluble boron concentration during daily maneuvers with control rod movements, thereby reducing the amount of waste water generated during the cycle and greatly simplifying the design of the chemical volume and control system. The control banks moved for T_{avg} (average temperature) and axial power shape control are independent of each other and in the Westinghouse AP 1000 are automatically controlled by the rod control system above 15% of rated thermal power, thereby simplifying load follow maneuvers as well as base load operations.

While specific embodiments of the invention have been described in detail, it will appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

1. A nuclear fuel assembly for a light water reactor comprising a spaced array of a plurality of MOX fuel rods arranged in rows and columns wherein the spaced array of the plurality of fuel rods is arranged in a radial enrichment zoning pattern comprising at least three zones at each radial position, an inner zone, an intermediate zone and an outer zone, with the Pu weight percent enrichment of the fuel rods within each zone being substantially the same and the Pu weight percent enrichment of the fuel rods between zones decreasing as one moves radially outward from the inner zone of the fuel assembly from one zone to the next with the outer zone having all of the fuel rods around the entire border of the fuel assembly, in both outer columns and rows, of substantially the same weight percent enrichment and the intermediate zone having substantially more fuel rods relative to the inner zone and the outer zone respectively.

2-6. (canceled)

7. The fuel assembly of claim 1 without any burnable absorber.

8-9. (canceled)

10. The fuel assembly of claim 1 wherein the Pu weight/percent enrichment is about 1.00 for the inner zone, about 0.65 for the intermediate zone and about 0.45 for the outer zone.

11. The fuel assembly of claim 1 comprising a square array of 17×17 fuel rods wherein the inner zone has approximately 72 fuel rods, the intermediate zone has approximately 128 fuel rods and the outer zone has approximately 64 fuel rods.

12. The fuel assembly of claim 1 wherein the outer zone consists of an outer peripheral row of fuel rods that circumscribes the fuel assembly.

13-19. (canceled)
